(19) United States
(12) Patent Application Publication
(10) Pub. No.: US 2013/0007748 A1
(43) Pub. Date: Jan. 3, 2013

(54) TEN-LEVEL ENTERPRISE ARCHITECTURE SYSTEMS AND TOOLS

(76) Inventor: Kerry John Enright, Rancho Cucamonga, CA (US)

(21) Appl. No.: 13/541,556

(22) Filed: Jul. 3, 2012

Related U.S. Application Data
(62) Division of application No. 12/425,318, filed on Apr. 16, 2009, now abandoned.

(51) Int. Cl. G06F 9/46

(52) U.S. Cl. 718/100

(57) ABSTRACT

This disclosure describes sets of systems and tools that drive complex enterprise execution logic top to bottom, end to end and site to site through the discrete execution and control of ten levels of mission-critical enterprise structure:
1. Execution logic: drive operations end to end, top to bottom, site to site
2. Rules: govern a process step execution
3. Information: track states of enterprise objects or go/no decisions
4. Data: capture and use measurements or events
5. Specifications: guide operation for particular programs
6. Templates: prepackage execution logic models
7. Identification: name critical enterprise resources for common management
8. Users: represent the extended enterprise community
9. Services: provide physical or logical procedures, functions, modifications or measurements
10. Controls: monitor, evaluate and control named material at specific process steps

The ten-level enterprise architecture provides effective and efficient tools for executing complex globally collaborative enterprise processes.

### CROSS-REFERENCE TO RELATED APPLICATIONS

This application is a divisional of U.S. application Ser. No. 12/425,318, titled “TEN-LEVEL ENTERPRISE ARCHITECTURE SYSTEMS AND TOOLS,” filed Apr. 16, 2009, the specification of which is hereby incorporated by reference in its entirety.

### BACKGROUND OF THE INVENTION

1. Field of the Invention

The disclosed technology relates to a method of performing a process in a multi-level hierarchy, and more particularly to managing data and operations to optimize the process.

2. Description of the Related Technology

In various industries, service providers and sellers and manufacturers of goods use complex processes to serve their customers. The processes receive information and goods from various sources at various levels of a hierarchical organization. The levels of organization cooperatively use the information and goods to produce and provide sellable products. The efficiency and effectiveness of the organization is highly dependent on the coordination, processing, and sequence of steps used by the various levels of the organization.

Higher throughput, quality, and profitability may be achieved through concentrated improvement of the organization and its processes. Industries which may particularly benefit from such improvements include health care, education, manufacturing, and service providers.

### SUMMARY OF CERTAIN INVENTIVE ASPECTS

The ten-level enterprise architecture is designed not only to resolve the limitations of prior-art business information architectures, but also to deliver a completely new level of enterprise process execution. Prior art enterprise information architecture includes client-server architecture and service oriented architecture, aka SOA.

Client-server architecture, developed in the 1980's was designed to alleviate the problems of monolithic applications. While monolithic applications provided customers with holistic solutions, their tight interlocking of components made business and system flexibility, maintainability, extensibility and growth nearly impossible. Client-server architecture significantly improved these shortcomings by segregating the user interface and data from the application. This immediately delivered a higher level of flexibility and opportunity for growth.

It was discovered however that client-server architecture itself had limitations for what was called application actually had two distinct components—service and business logic. Service was composed of specific procedures and functions that provided usable answers for the business process. Business logic was the actual workflow model of the enterprise. The response was to create a new architecture called service oriented architecture that divided business logic from service thereby enabling businesses to dramatically improve flexibility and the capacity to tailor solutions more closely to the business execution tools.

Service oriented architecture however has significant shortcomings of its own. The first shortcoming is that while business logic has been properly segregated from service, the architecture never defined a structure for actually executing the business logic. It simply leaves this crucial function up to the imagination of individual developers with widely varying results. In most cases, the execution logic is never systematized and is executed manually through the users of the system. Second, what SOA calls ‘data’ is not simply data but actually a combination of entities: rules, information, data and specifications. Each of these entities has its unique lifecycle flow and vital interaction with the logical business workflow. Again, SOA provides the user no support in this area meaning that it is seldom systematized. Finally, SOA offers no specific solution to the problem of naming the components of the system in a consistent and managed fashion.

The ten-level enterprise architecture not only solves the short-comings of SOA, it goes far beyond it by providing the business and technical infrastructure for a new concept of the enterprise—the globally collaborative enterprise. These enterprises are characterized by complex integrations of programs, processes, sites, organizations, users and ownership. Because this type of enterprise has become so prevalent worldwide, robust solutions are needed, but prior to now no system has been designed to meet the enormity and complexity of this task. The ten-level architecture changes all of that.

The ten-level enterprise architecture systems and tools innovates management tool for complex enterprise across four dimensions—top to bottom, end to end, site to site and time to time—and links them together seamlessly.

1. A core enterprise execution logic system embodies all business processes from top to bottom, end to end, site to site in a standard, holistic and integrated structure

2. A system manages rules, information, data and specification through its own lifecycle that intersects seamlessly with the enterprise execution logic system

3. A system creates, executes and archives process templates within the enterprise execution logic structure to instill best practices across the enterprise

4. An identification system names all components of the architecture for seamless linkage through an enterprise service bus

5. A system for user integration not only supports access and security, but also enables collaboration, financial management and transmission requirements

6. A system integrates services with the enterprise execution logic system

7. A system monitors, evaluates and controls material processing within the enterprise execution logic system

These innovations enable enterprises to create, utilize and grow complex business processes that deliver high quality execution time after time.

### BRIEF DESCRIPTION OF THE DRAWINGS

FIG. 1 100 Ten-Level Architecture Overview: A holistic view of the ten-level enterprise architecture system and tools with all of its component systems

FIG. 2 200 Enterprise Execution Logic System: a depiction of the enterprise execution logical and physical process levels including the site exchange process

FIG. 3 200 Enterprise Execution Logic System: a view of the control items, factors and variables for site exchange

FIG. 4 200 Enterprise Execution Logic System: a view of the control items and control factors for system exchange.

FIG. 5 200 Enterprise Execution Logic System: a depiction of the enterprise execution logic input, function and output structure and each of their sub-components

FIG. 6 200 Enterprise Execution Logic System: A depiction of the execution measurements used to assess the performance of each step

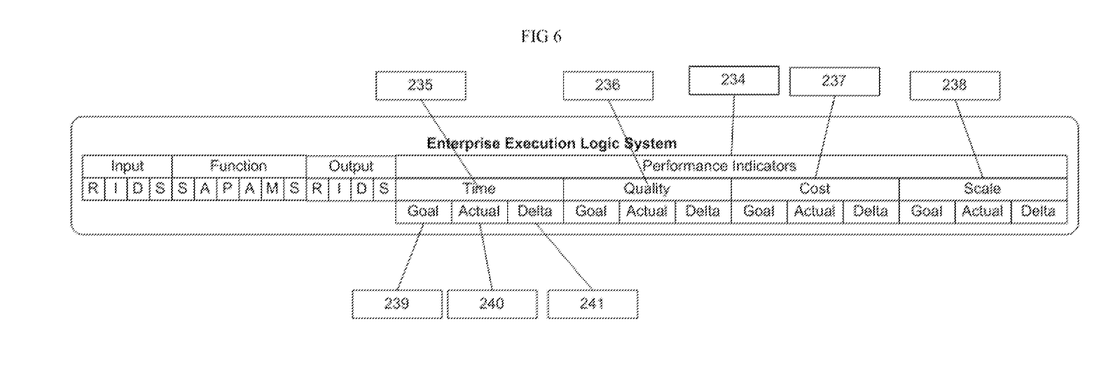

FIG. 7 200 Enterprise Execution Logic System: A depiction of the capture of innovations required at each step to meet performance criteria

FIG. 8 200 Enterprise Execution Logic System: A view of the intra-process end to end execution structured with the higher level initiate, execute and complete sectors as well as their sub-segments

FIG. 9 200 Enterprise Execution Logic System: An example of a branch condition to an exception process at any step in the process

FIG. 10 200 Enterprise Execution Logic System: A depiction of the identification of the enterprise execution logic levels and their many to many linkages between levels

FIG. 11 200 Enterprise Execution Logic System: A picture of the methodology of direct linkage between different levels in the enterprise execution logic hierarchy

FIG. 12 200 Enterprise Execution Logic System: A description of the identification method for each step in a process

FIG. 13 200 Enterprise Execution Logic System: A view of the method for identifying the process columns from input, function, output, indicators and innovation

FIG. 14 200 Enterprise Execution Logic System: An example of how a cell has a unique identifier within a process

FIG. 15 200 Enterprise Execution Logic System: A sample of the linkage of the owner and a source for each cell identifier

FIG. 16 200 Enterprise Execution Logic System: An image of how updated rules, information, data or specifications get pushed back to its logical repository

FIG. 17 200 Enterprise Execution Logic System: A description of how a service is called from the service function within a process step

FIG. 18 300 RIDS Management System: A sample of how a rule is updated using the enterprise execution logic as the lifecycle management engine

FIG. 19 300 RIDS Management System: A picture of the rules, information, data and specifications lifecycle management structure

FIG. 20 300 RIDS Management System: A drawing of the rules, information, data and specifications lifecycle and version management using the enterprise execution logic system

FIG. 21 300 RIDS Management System: A sample of the qualification of rules, information, data and specifications including naming, coding, availability and ownership

FIG. 22 300 RIDS Management System: A depiction of the linkage of the rules, information, data and specifications with the enterprise execution logic system

FIG. 23 400 Template Creation System: A description of the template creation system linking to the RIDS management system and the services system

FIG. 24 400 Template Creation System: An outline of the template creation lifecycle management

FIG. 25 500 Identification System: An outline of the identification system

FIG. 26 500 Identification System: An image of the interconnected management of the identification system with the other components of the Ten-level architecture

FIG. 27 500 Identification System: A picture of the tracking of the physical location of the process and the process material

FIG. 28 500 Identification System: A description of the linkage between the change of physical location using the dispatch function, the site exchange process and summarizing it in the identification system

FIG. 29 500 Identification System: A view of the tracking of material ownership

FIG. 30 500 Identification System: A depiction of the linkage between the named service and the actual service within the services system

FIG. 31 500 Identification System: A description of the linkage between the identification system and the user system

FIG. 32 500 Identification System: An image of the integration of the identification system and the enterprise service bus managing the ten-level architectural components

FIG. 33 600 User System: An overview of the user system showing the user role definition, the access and security requirements, the lifecycle management and the identification system linkage.

FIG. 34 900 Monitor, Evaluate, Control System: A depiction of the monitoring and evaluation of the enterprise execution logic structure and named material at process steps.

FIG. 35 900 Monitor, Evaluate, Control System: A description of the method for exercising control of input rules, information, data and specifications as well as the control of named material at a process step and the ability to branch to an exception process.

FIG. 36 900 Monitor, Evaluate, Control System: A view of the ability of the system to evaluate process variances from the planned performance indicators.

FIG. 37 900 Monitor, Evaluate, Control System: A picture of the ability of the system to provide temporary overrides for named materials.

### DETAILED DESCRIPTION OF CERTAIN INVENTIVE EMBODIMENTS

The purpose of this disclosure is to provide enterprises with the capability of constructing, executing and controlling complex processes and systems from top to bottom, end to end and site to site. It is designed to overcome the shortcomings of all prior art by being a holistic execution-oriented framework.

### 100 Holistic Framework

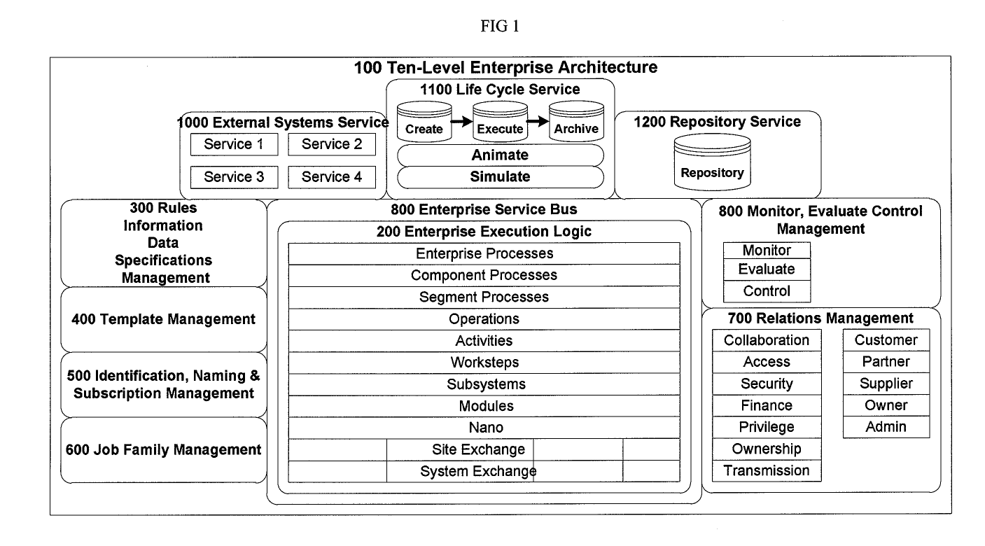

FIG. 1 shows the holistic structure of the Ten-level enterprise architecture system and tools. The ten-level architecture 100 contains the following components:

200, the enterprise execution logic system

300, the rules, information, data and specifications management system

400, the template creation system

500, the identification system

600, the user system

700, the services system

800, the enterprise service bus

900, the monitor, evaluate and control system

These components are linked together to provide a complete solution to the execution of complex enterprises.

### 200 The Enterprise Execution Logic System

Top to Bottom Management

The first purpose of the enterprise execution logic system is to provide any enterprise the control structure to execute processes top to bottom. This method system is divided top to bottom by a hierarchy of logical and physical processes. Logical processes are characterized by the use of logical actors, materials and services while physical processes are characterized by the use of tangible physical actors, materials and services.

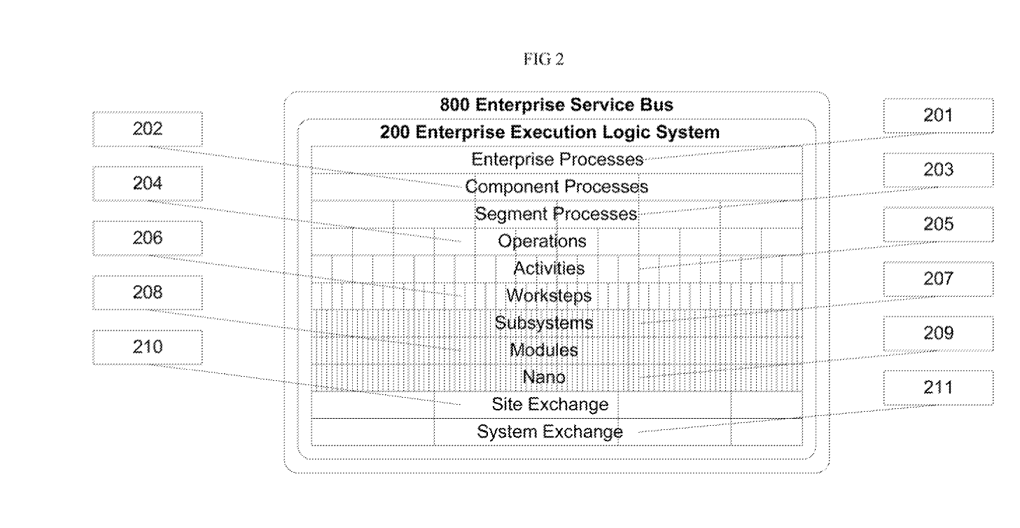

The highest level 201 is the enterprise logical process, FIG. 2. This process embodies a set of universal enterprise activities including plan, develop, design, produce, deliver, market, sell and support processes. An enterprise can be a single entity such as a company, government or agency or it can be a collaborative entity with multiple companies, governments and agencies. An enterprise can use the 201 enterprise logical process to manage all or a subset of these functions.

The next level is the 202 component logical process. This process manages the creation of logical and physical components that comprise the enterprise level process which are sufficiently complete to be offered for sale. For example, an enterprise may provide truck chassis to a freighting company for their fleet build; a semiconductor company may provide signal chips to a cell phone maker, or a legal firm may deliver contracts for a merger. While these offerings are not the end solution in themselves, they are vital components that need to be managed in the context of the greater enterprise.

The third level is the 203 segment logical process. This process manages segments of work required for creating components where specific conditions apply—the need to recognize billing for work accomplished, the need to acknowledge a set of operations, 204, that necessarily have to be processed together as a unit/site or the need to group operations for progress reporting. In long complex processes, process segments often need to be established so that billing can be executed based on completion of logical groupings of work even though the product or service is not finalized. In other cases, segments need to be created to ensure that certain operations are grouped together because any break in time or location results in the deterioration of the product or service under production. Finally, segments need to be established simply for reporting the progress of long, critical or risky programs.

The fourth level is the 204 operation logical process. An operation is the process of modifying a product or service. In semiconductor manufacturing, this can be the testing of a wafer. In design, it can be a first level layout. In the legal profession it can be the creation of a damages clause.

The fifth level is the 205 activity physical process. An activity, as a physical process, identifies specific actors, materials and systems for execution. It is a logical grouping of 206 worksteps such as ‘log in’ to a system or ‘collect information’ for writing a contract clause

The sixth level is the 206 workstep physical process. A workstep is the specific discrete action required to enable a system to execute. For a log in activity, the worksteps would include acts of entering data into specific fields. For collect information, it could include selecting a file from an archive.

The seventh level is the 207 sub-system physical process. A sub-system is an integral component to a system that enacts a procedure or function. The sub-system could be the robot arm that picks up a part and loads it on a tool. It could be the search algorithm that identifies a requested file or it could be the authorization filter to allow user access.

The eighth level is the 208 module physical. A module is an encapsulated function within subsystems. An example of a module could be a molded set of signal processing chips in a cell phone that convert an incoming signal from digital to analogue.

The ninth level is the 209 nano physical process. A nano is a function within a fabricated monolithic structure that returns specific procedures or values. An example of this could be a cache memory circuit within a signal processing chip.

This execution hierarchy provides the ability to add new levels of hierarchy as business needs arise. In such cases, consistency can be maintained provided that the inter-level links to be described in the end to end management section below are established.

The innovation of these nine levels of enterprise execution logic is that they provide a seamless integration of mission critical processes from top to bottom as a single set in a coherent framework. It comprehends the highest level of an enterprise down to the lowest yet maintains the potential for unbroken linkage by ensuring that the hand off of execution between levels that is complete and correct. An enterprise decides on the number of levels that it desires to introduce for managing its processes and then design of the processes. Since the enterprise execution logic is a set of open ended hierarchical, new processes can be added at any time.

### Site to Site Management

A second purpose of the enterprise execution logic system beyond top to bottom integration is to enable complex enterprises to integrate work site to site across a plurality of physical and logical locations under a multitude of ownership models. The 210 site exchange logical process allows an enterprise to exchange its physical or logical materials from one site to another. The site exchange process can be inserted between any two logical or physical processes.

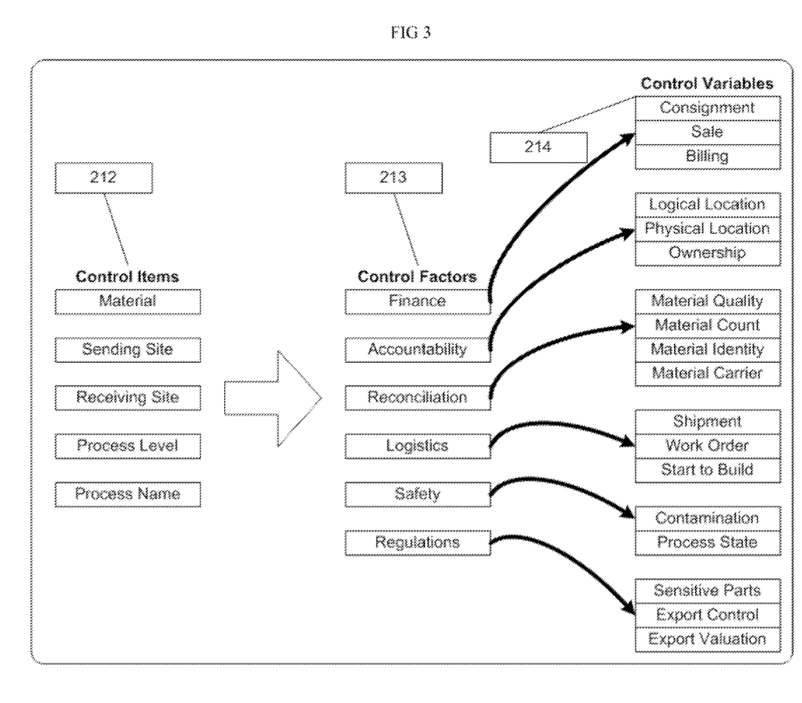

Per FIG. 3, the site exchange logical process manages the protocols required for exchange material between sites including the control items 212, the control factors, 213 and the control variables 214. The control items include the material requiring exchange, the sending and receiving sites, and the process levels and name to ensure execution compatibility.

The control factors managed by the site exchange include finance, accountability, reconciliation, logistics; safety and regulations. These in turn drive a set of control variables.

For example, the financial considerations may include the payment against contracts for goods and services flowing between companies. Accountability comes into play when goods and services are moved from one organization and the physical and logical location and organizational responsibility have to be validated. Reconciliation is required when goods and services are moved from one organization to another and there are changes to quantity, cost or quality to the goods and services that need to be verified. Logistical protocols concern the nature and method of moving goods and services from one site to another. Safety covers a multitude of issues such as contamination containment or compatibility hazards. Finally, in international exchange, regulatory requirements affect the payment of duties or the management of sensitive technology. As example, a document can sail across borders at the touch of a button, but if there are technology restrictions on the transfer, the exchange needs to be controlled. Each of the control variables represent rules and specifications within in the end to end structure to be described in the end to end management section next. The 210 site exchange logical process can be inserted at any level of the execution hierarchy any number of times.

The innovation in this execution logic is threefold. First, it formally recognizes the unique processes of site exchange and provides the specific means of integrating this with standard processes. Second, it manages the specific site exchange content required for successful execution. Third, it creates a flexible enterprise architecture by allowing insertion of the site exchange at any level in the execution hierarchy.

### System to System Management

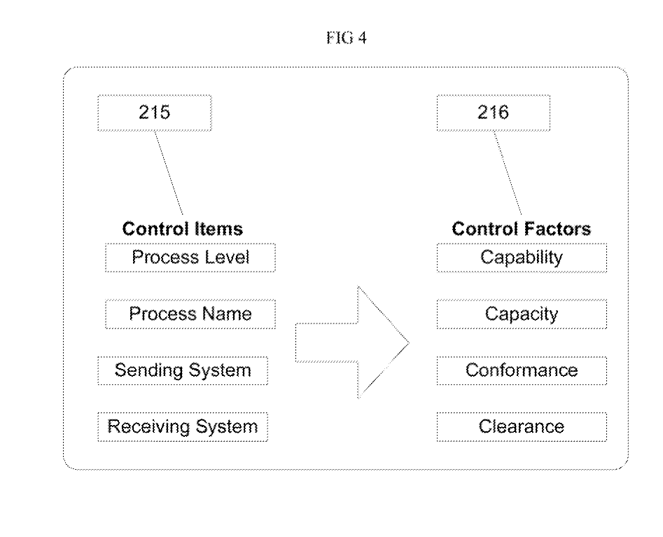

Globally collaborative enterprises may need to exchange not only the execution of processes but also the systems upon which they are executed per FIG. 2, 211. Globally collaborative enterprise would often require the exchange of systems as execution is share among the members. Per FIG. 4, the system to system exchange management allows the transfer of process execution at the system level accounting for capability, capacity, conformance and clearance. Capability is the validation that the target system is able to run the process management; while capacity confirms the availability of process power, bandwidth or storage. Conformance is the assurance that the target system has the correct configurations, guidelines and controls for executing the processes; while clearance is the validation that the target system is approved for use. Each of the control factors has a set of control variables that are articulated in the system to system exchange management as rules and specifications in the end to end management. The system exchange can be triggered manually at any time or automatically with the site exchange management structure.

The innovation in this system is the ability to embed in the middle of a process execution structure the reality that the system control will be exchanged as well. This enables collaborative enterprises to share resources with great facility and control

### End to End Management

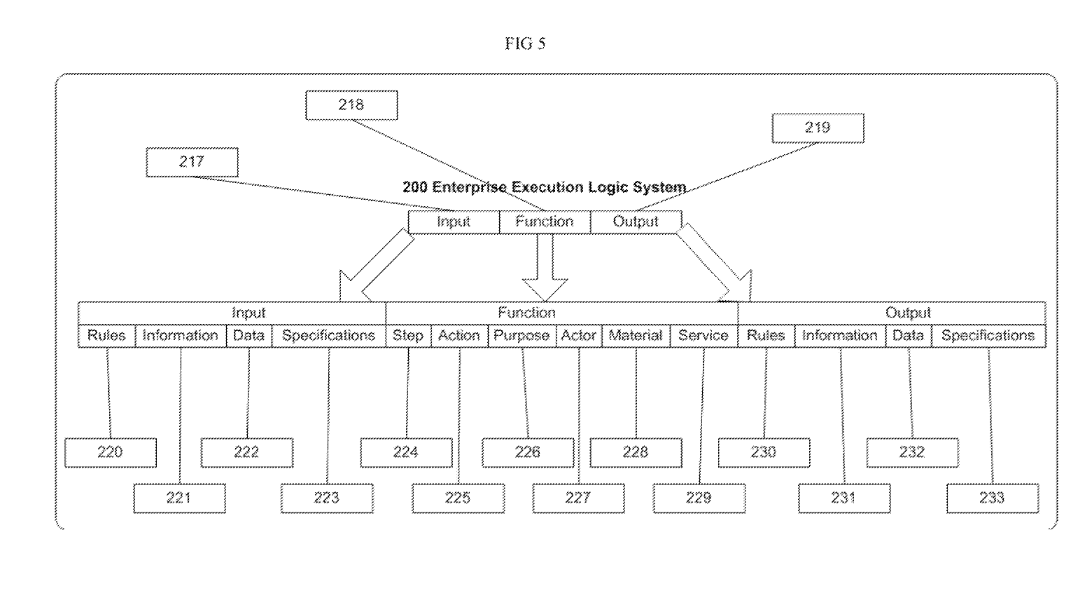

Enterprises however need to manage end to end integration as well as top to bottom, site to site and system to system unification and therefore the 200 enterprise execution logic system includes the capabilities to manage these processes within themselves through to completion. To achieve end to end management of each process level, the architecture provides an extensive suite of inventions as shown in FIG. 5.

Each logical and physical enterprise execution logic process is structured by 217 input, 218 function and 219 output. This structure in itself is not novel because it has been used as prior art in applications such as computer programming. The real innovation in the input, function, output structure lies in the development of the unique and complete set of self-consistent sub-components in this invention, sub-components not created or used in prior art.

The 218 function component is comprised of 224 step, 225 action, 226 purpose, 227 actor, 228 material and 229 service. The 224 step is a sequential ordering of the actions taken in an execution process. The 225 action is a unique named description of the contents of the step. The 226 purpose is a documented narrative of why this action is required. The 227 actor is a unique description of the logical or physical human, organization or technology that executes the action. The 228 material is the physical or logical goods or services being worked on. The 229 service is a named function, procedure or tool that returns values or alters or measures the material. While each component of 224 function is simple; as a comprehensive and unified set they are non-obvious in actual usage within a step. Holistically, they allow the action to be self-describing for precise execution control and traceable for process improvement.

In addition, the 218 function has critical input and output dependencies to produce the correct result so it is bracketed by 217 input and 219 output components. The 217 input component provides the 220 rules, 221 information, 222 data and 223 specifications required to correctly execute a step. The 220 rules govern how a 224 step is supposed to be executed, and this governance applies across multiple programs of the same type. The 221 information provides the process state information to enable correct sequencing and go/no go decision execution. The 222 data provides captured events and measurements used to determine if the state of something has changed. The 223 specifications provide business and technical guidance for a specific program using this logical or physical process.

The other side of the 218 function is the set 219 output components. The 230 rules component captures any creation of or changes in the 220 input rules as a result of the actions taken in the step. The 231 information component records any modification of the 221 information input caused by the step actions. The 232 data captures any data generated by the step actions. The 233 specification records the creation or change in the 223 specification caused by the step action.

The mission critical novelty of the 217 input and 219 output components is the discrete recognition and management of rules, information, data and specifications. Worldwide systems simply use the term ‘data’ or ‘information’ when referring to the inputs and outputs. This lack of recognition, formalization and management of these unique entities is the root cause of widespread misprocessing and faulty execution with the following problems being painfully common:

Lack of common definition

Failure to control version and state

Unable to locate at execution time

Unable to link directly to execution

Failure to retire when obsolete

This novel architecture corrects these worldwide execution flaws.

Since process improvement is integral to enterprise survival, the 234 performance indicators provide the facility to track each step by its key performance measurements. These indicators are selected by their universal nature and ability to be summarized across multiple levels of logical and physical processes. The 235 time indicator measures the time to execute a step. The 236 quality measures the number of errors or lack thereof in the step execution. The 237 cost measures financial or resource consumption required by the step. The 238 scale measures the throughput or volume accomplished by the step execution.

Each indicator has a three part structure—goal, actual and delta. The 239 goal cell is created and stored when the process is defined. The 240 actual cell is captures the real execution information from the process step. The 241 cell is a differential calculation between the plan cell and the actual cell. The delta cell has the ability to trigger an alert if it is outside of preset limits.

The innovation in 234 performance indicators is fourfold. First, it embeds the indicator into every process step so that every step can be measured. This means that from the very top to the bottom of a giant enterprise, every step has the potential for measurement —a potent tool for process improvement. Second, the measurements are simple and universal. The major limitation of key performance indicators commonly used in industry is that they are complex and not comprehensible or even relevant horizontally or vertically across the enterprise. The simplicity and clarity of the indicators ensures that all persons and systems can recognize them. Third, as will be seen in 265, these performance indicators are scalable from the bottom of the enterprise to the top and back. Fourth, the indicators can compare the plan to actual performance at any step and send out an alert when limits are violated.

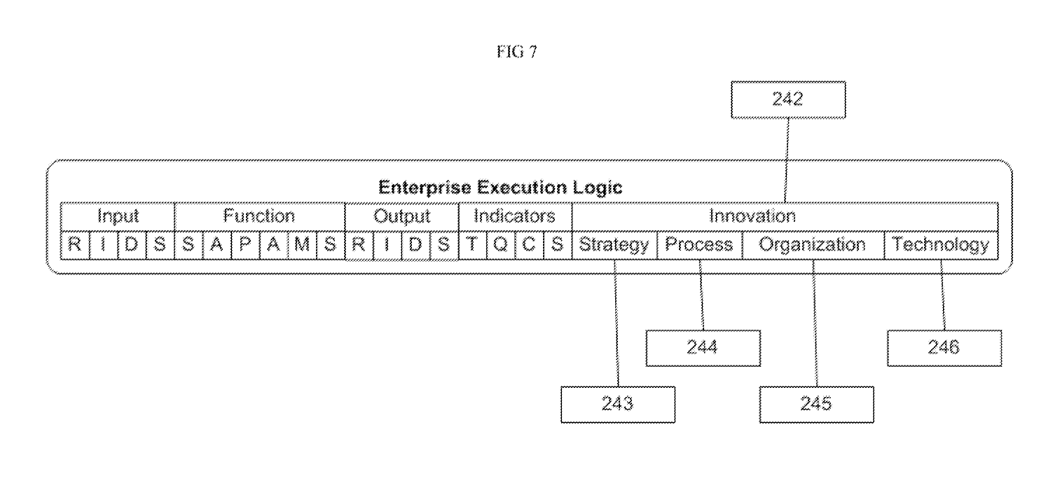

In conjunction with measuring process execution performance, enterprises need to apply the knowledge from the measurements to improve the overall business performance. To this end, enterprises need to highlight the specific innovation required to achieve performance improvements. FIG. 7 describes the 242 innovation requirements to meet the performance for each step. The 243 strategy captures changes in strategy needed for improvement while 244 process contains the change in process required. The 245 organization describes the changes to the organizational structure, roles, skills or size to accomplish the metrics and the 246 technology contains the physical or logical technology needed to support the 244 process or the 245 organization. This 242 innovation function is unique because it introduces improvement requirements into every step of the process at any level of execution in the enterprise. This innovation, linked with the 218 function elements, allows enterprises to analyze, plan and execute continuous improvement.

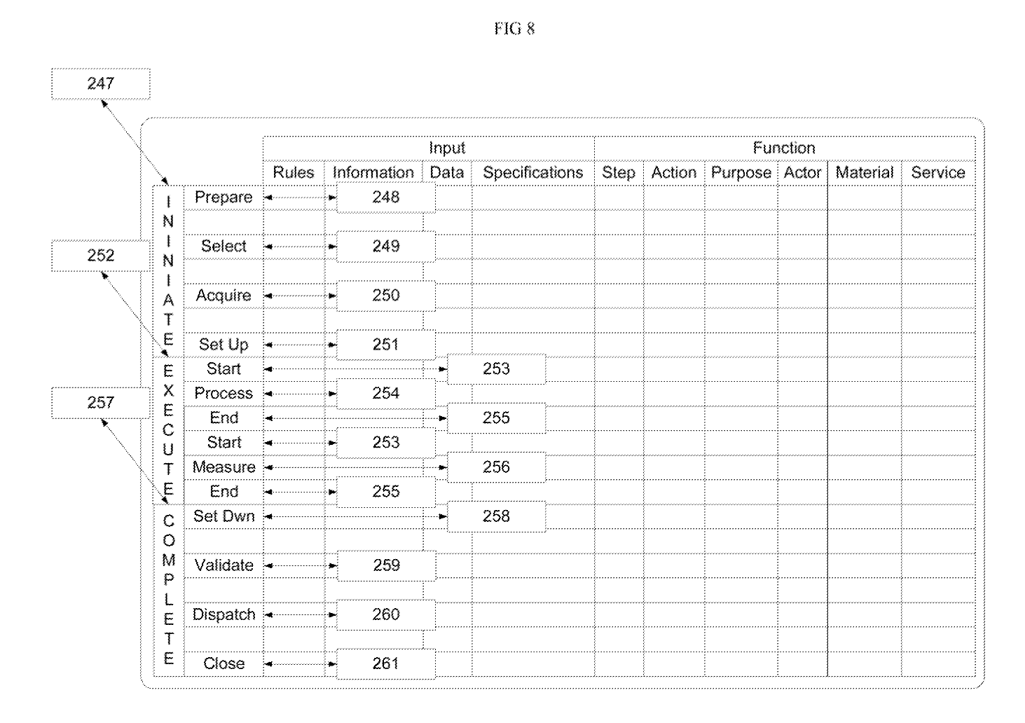

To ensure complete end to end execution of the process level, FIG. 8 depicts a 247 initiate, 252 execute and 257 complete structure that is overlaid on the 217 input, 218 function, 219 output, 234 performance and 242 innovation structure. There are two major innovations in this structure. First, although the initiate, execute and complete structure is often used in advanced development enterprises, this is the first time that the initiate, execute, complete structure has been overlaid on the input, function, output structure thereby creating a complete matrix. The second major innovation is the robustness of the structure within the 247 initiate, 252, execute and 257 complete structure.

There are two novelties to the robustness of the initiate, execute and complete structures. The first is the completeness of the sub-structures that drive end to end execution steps for quality execution. The second is that the 247 initiate and the 257 complete explicitly manage the rules, information, data, specifications, actor, material and system functions. It is this functional interlocking that ensures high quality—complete and correct—process execution, and is applicable for any type of process execution.

The 247 initiate function ensures that a process is correctly established for execution through its constituent elements comprising 248 prepare, 249 select, 250 acquire and 251 set up. The 248 prepare function examines availability of the rules, information, data, specifications, actor, material and service before executing a process can be considered. In manufacturing for example, this function would check for the process recipe, the correct process state, the feed forward data, the program override, the availability of certified operators, the availability of the lot and approved tools.

Upon completion of prepare, the 249 select function chooses the actor, material, system, rules, information, data and specifications necessary for the correct execution of the process. The 250 acquire function ensures that the 249 selected functions are made available for the execution. This can include paging the operator, fetching the lot of materials and reserving a tool. Finally, the 251 set up performs specific establishment of systems or other functions necessary for execution. Using the manufacturing example again, this can include logging in the operator, loading the process recipe, loading the lot on the tool and opening the tool chamber.

The 252 execute structure provides the framework for altering or measuring an entity. The 253 start records the beginning of the actual work. The 254 process is the altering of a product or service while alternatively the 256 measurement is the gaining of knowledge of an entity. The 255 end records the finishing of the process or measurement. These process or measurement actions can be repeated multiple times within a single 252 execute structure.

The 257 complete, as a complement to the 247 initiate, ensures the appropriate stand down of a process. The 258 set down is the opposite of the 251 set up. As an example, a tool may require cleaning after use. The 259 validate confirms that the components of the execution were all correct. In manufacturing, this may be the run of statistical process control to ensure that the process ran properly. If not, the tool and the lot may be placed on hold and further operations are stopped until corrective actions are taken. The 260 dispatch returns the actor, material, system, rules, information, data and specifications to their appropriate places for the next process and/or location. The 261 close records the completion of the process.

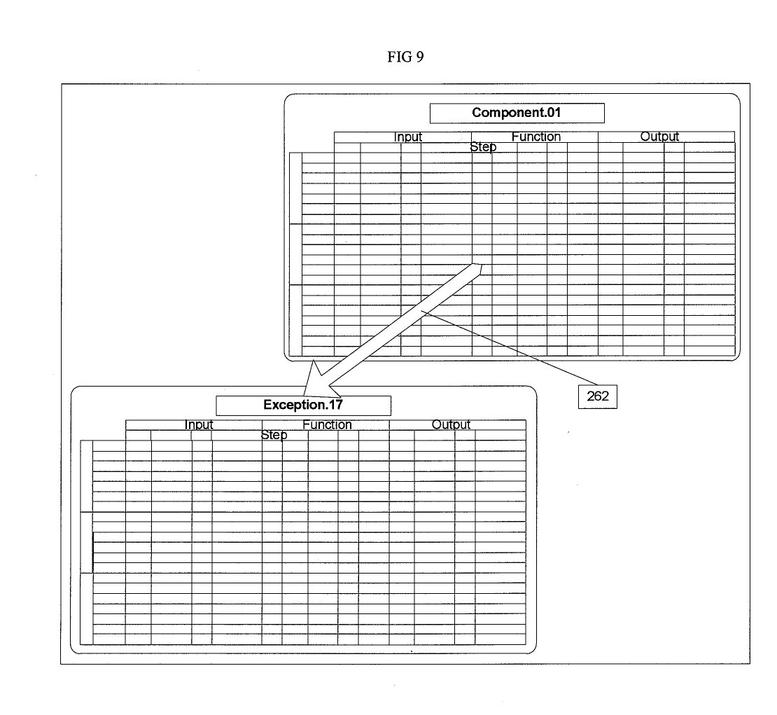

Things however go bump in the night and therefore processes have to provide for contingencies when they do. FIG. 9 shows the branch to a 262 exception process. The 262 exception processes can be inserted at any physical or logical process step. The 262 exception processes are triggered by defined aberrations in the step execution which call the exception process. Based on the type of aberration, exception processes are selected and executed with nesting and return locations. These exception processes can be created in advance using the 400 template creation system. The novelty of the system is threefold. First, the input-function-output/initiate-execute-complete structure provides, for the first time, all the information required to fully assess exception conditions. Second, the potential for exception process can be built into every process step. Third, the exception process can be created using the same enterprise execution logic structure as the standard processes.

### Integrating Top to Bottom, End to End, Site to Site

Precise execution requires robust integration of processes and functions and the 200 enterprise execution logic system is designed to ensure tight integration through hierarchical, horizontal and point linkages.

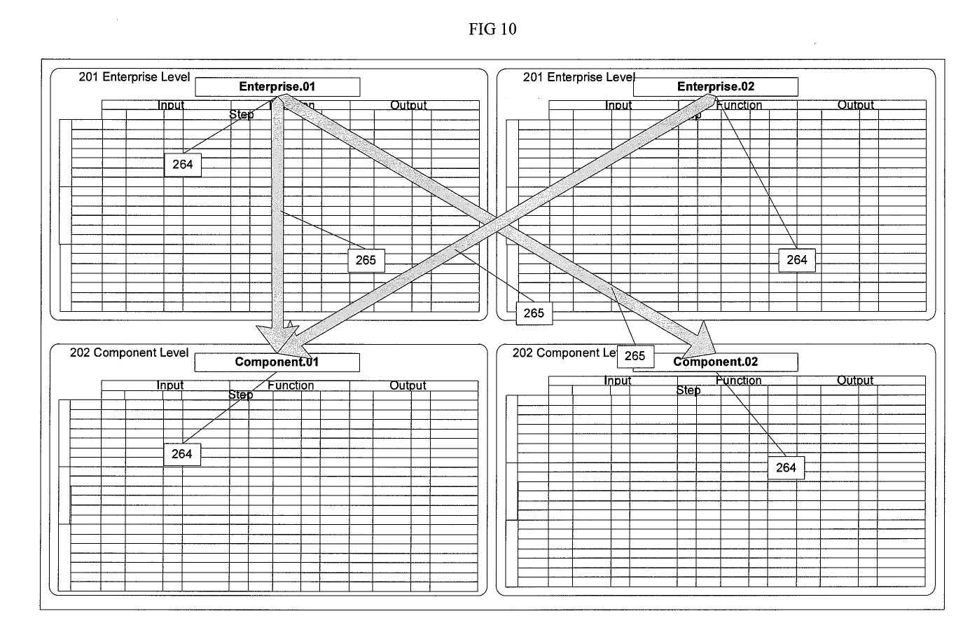

Hierarchical linkages are created by two tools per FIG. 10. The first is to provide a unique 254 identifier for each process in a process level. In complex organizations, there can be many types of processes at each level of logical or physical execution. For example, in a design organization, there can be system design, software design and material design which execute separately. This being the case, the distinct design processes need to be uniquely identified. Additionally, multiple enterprises can request the same design service for different purposes so the enterprises require discrete identification. Having identified the logical or physical process, the processes need to be linked together using the 264 process link. Note that if the process integration requires site to site transfer, a 262 site exchange process can be linked in between the two process levels. Finally, it should be noted per FIG. 10 that a plurality of higher and lower processes can be linked with each other. To support this capability, a repository of valid linkages and process substitutions is maintained.

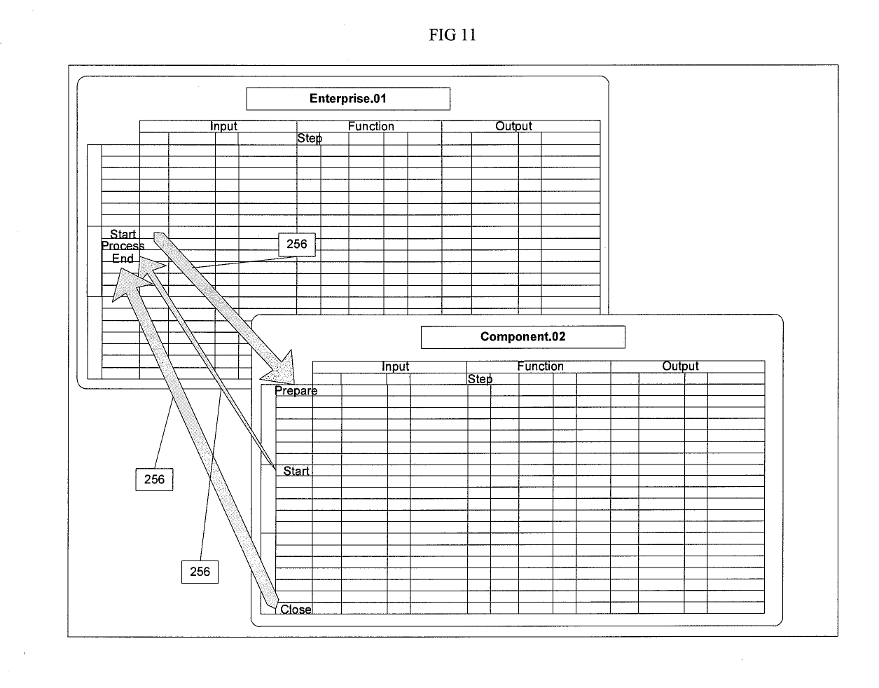

To ensure seamless process hand off and nesting of one process level to another, the 265 link provides hierarchical process to process integration. From the higher process level, the execute processes can link to the lower level initiate, execute, complete processes. Per FIGS. 8 and 11, the linkages are as follows:

| | | |
|---|---|---|
| Higher Level Process | Links to | Lower Level Process |

| | |
|---|---|
| Start 253 | Initiate 247 |
| Process 254/measure 256 | Execute 252 |
| End 255 | Complete 257 |

This structure allows for direct hierarchical connectivity that creates end to end and top to bottom process management. Additionally through these links, the performance indicators of the lower level initiate, execute and complete processes can be summarized upwards into the start, process/measure, end processes for accumulated process totals. Alternatively, companies desiring to drill down to find aberrations in the execution performance can use the downward links to find the sources.

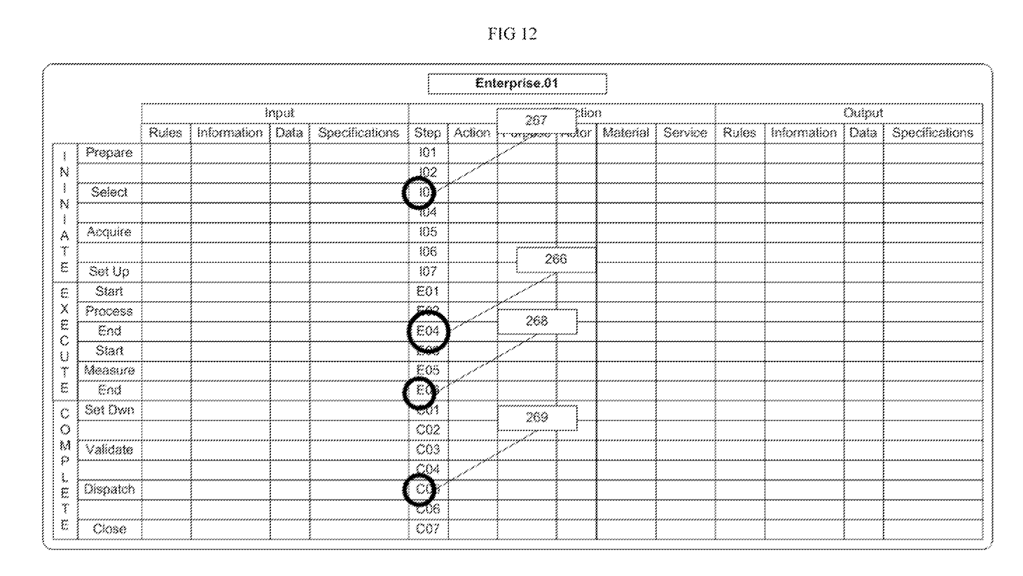

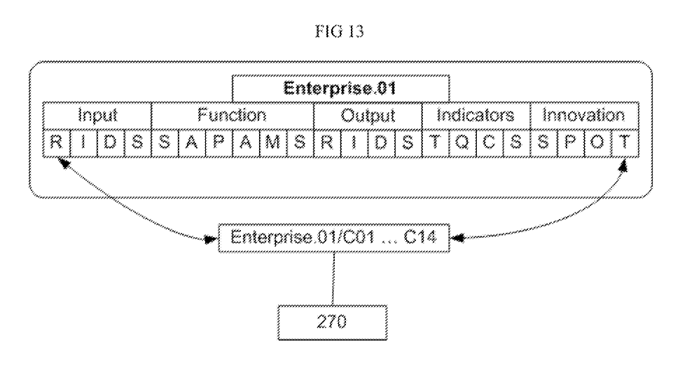

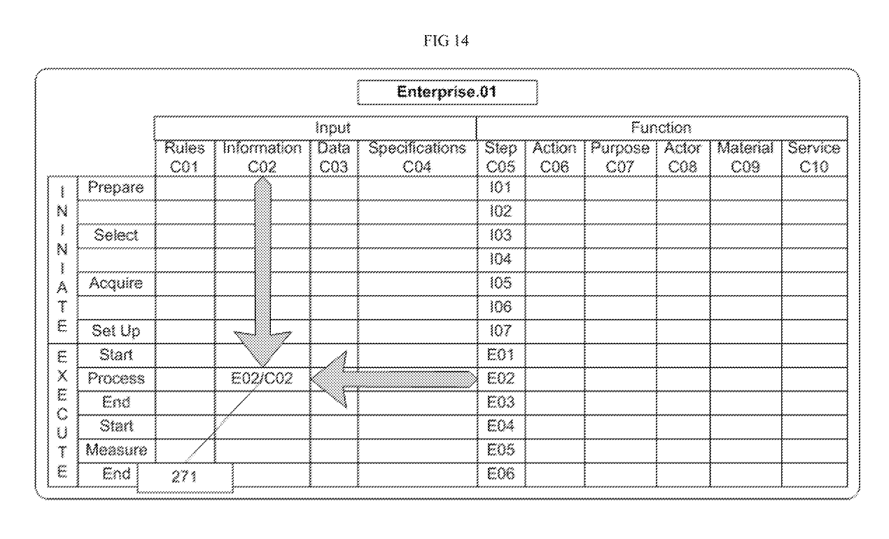

The integration through identification and linkages is carried into the process level itself to yield process execution precision. The 266 step number, shown in FIG. 12, provides a unique identifier for every step in a process level. Additionally, an ‘I’, ‘E’ or ‘C’ suffix is added to the step number to distinguish where it is an initiate, execute or complete step, 267, 268 and 269 respectively. The 270 column identifiers as shown in FIG. 13 provide unique column naming. Using the step identifier and the column id, unique 271 cell names can be produced per FIG. 14.

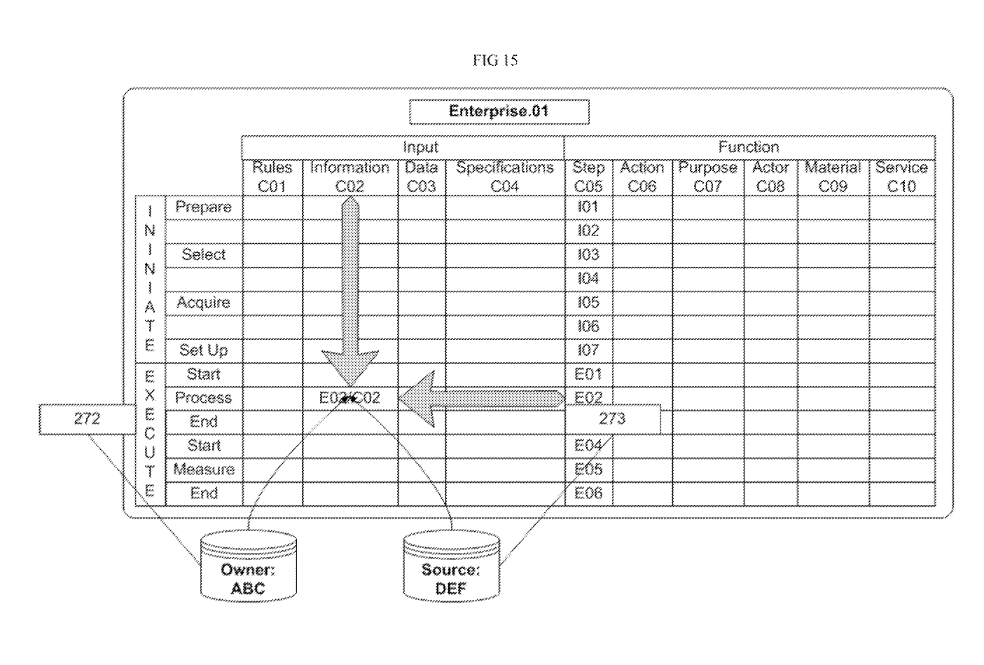

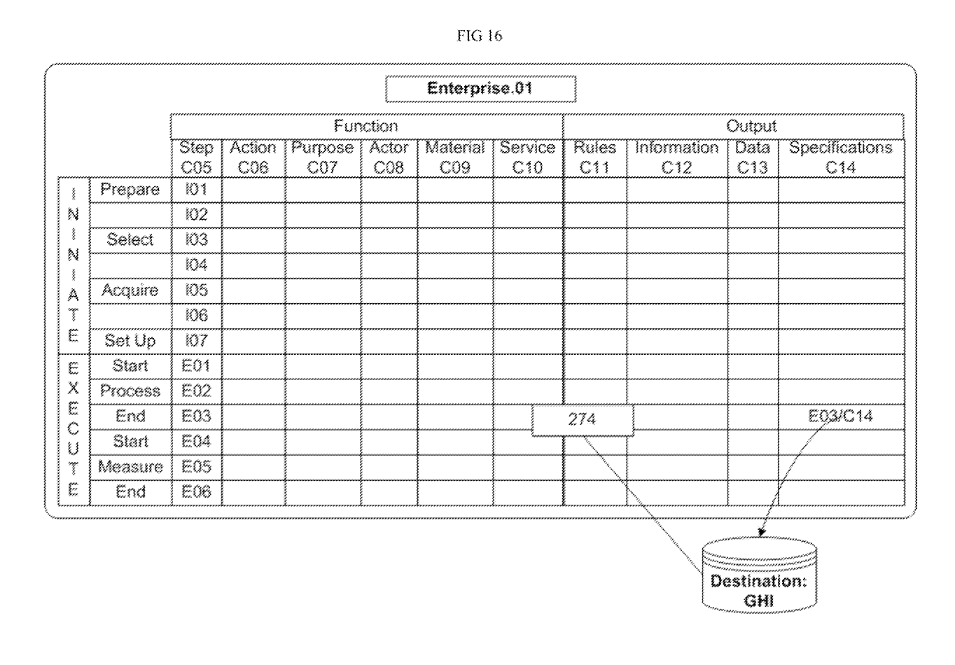

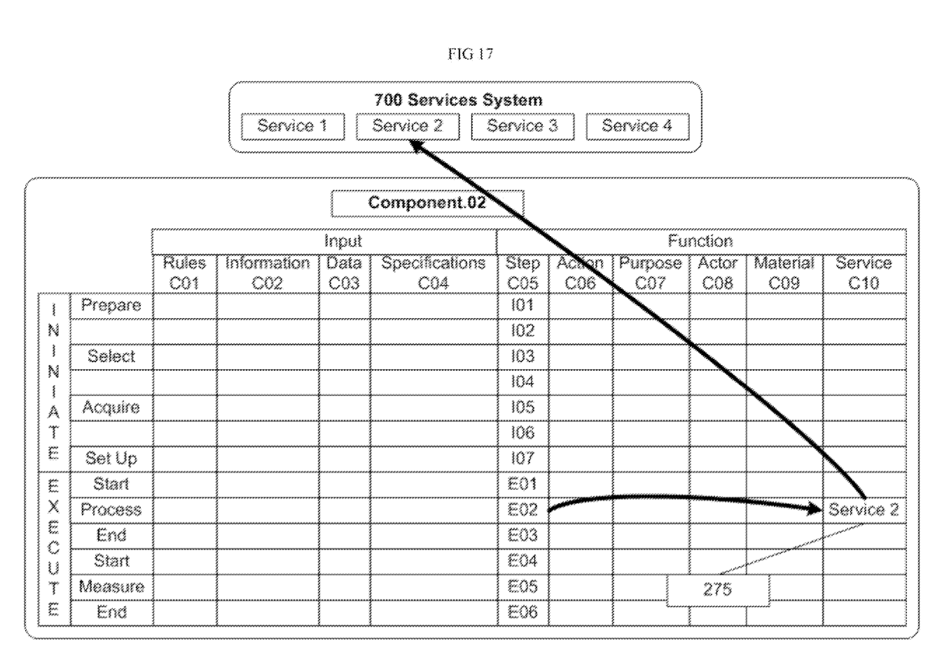

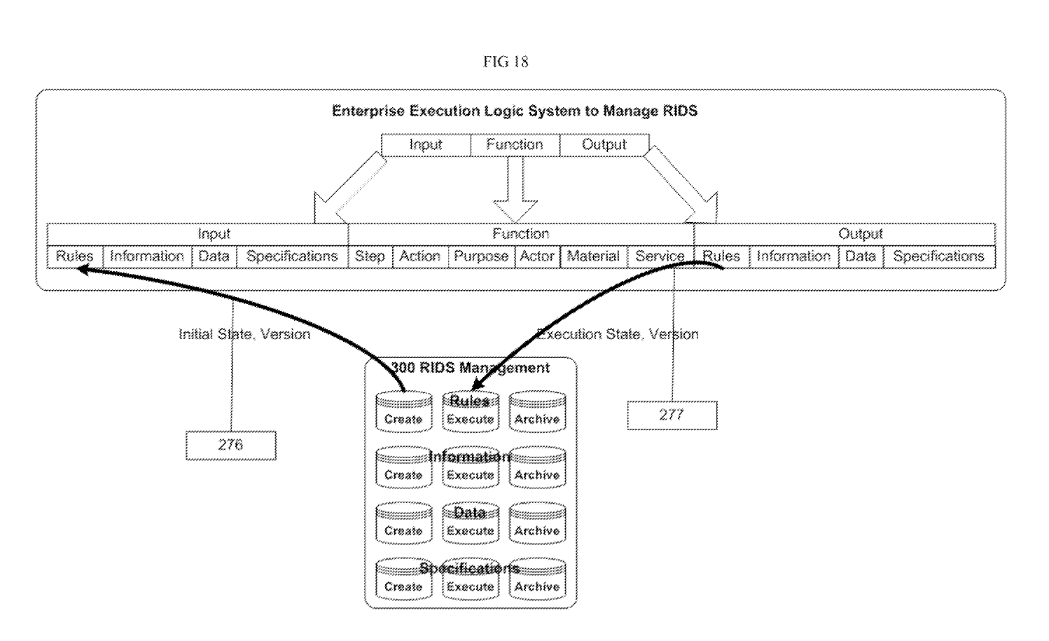

This identification structure is used to create effective execution linkages. Using the cell identification, each cell is assigned a 272 owner, a 275 source and a 274 destination in FIGS. 15 and 16. Similarly, 275 specific services can be called from any step/service cell per FIG. 17. Rules, information, data and specifications can be identified and called 276 or pushed, 277 and from any cell per FIG. 18.

These innovations provide an unprecedented level of execution connectivity across the enterprise and solving the perennial problems of top to bottom, end to end and site to site integration and control. They place the execution logic centric to the enterprise architecture with the integration points that allow all other components to support the core processes.

### 300 Rules, Information, Data and Specifications Management System

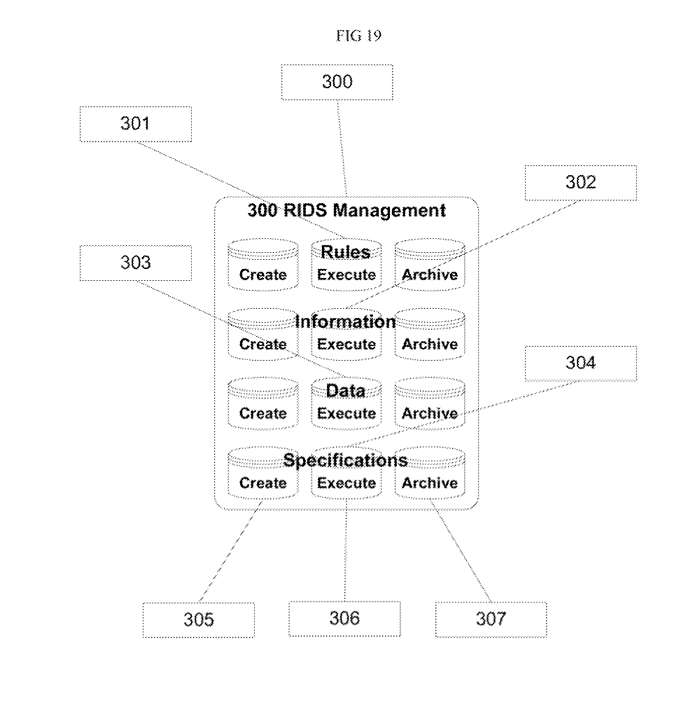

While most architectures provide data repositories consisting of data warehouses, the separate and distinct identification and management of rules, information, data and specifications, aka RIDS, is unique and novel. As shown in FIG. 19, the system provides distinct management for 301 rules, 302 information, 303 data and 304 specifications. Each of these is controlled within a set of repositories for 305 create, 306 execute and 307 archive to ensure lifecycle management.

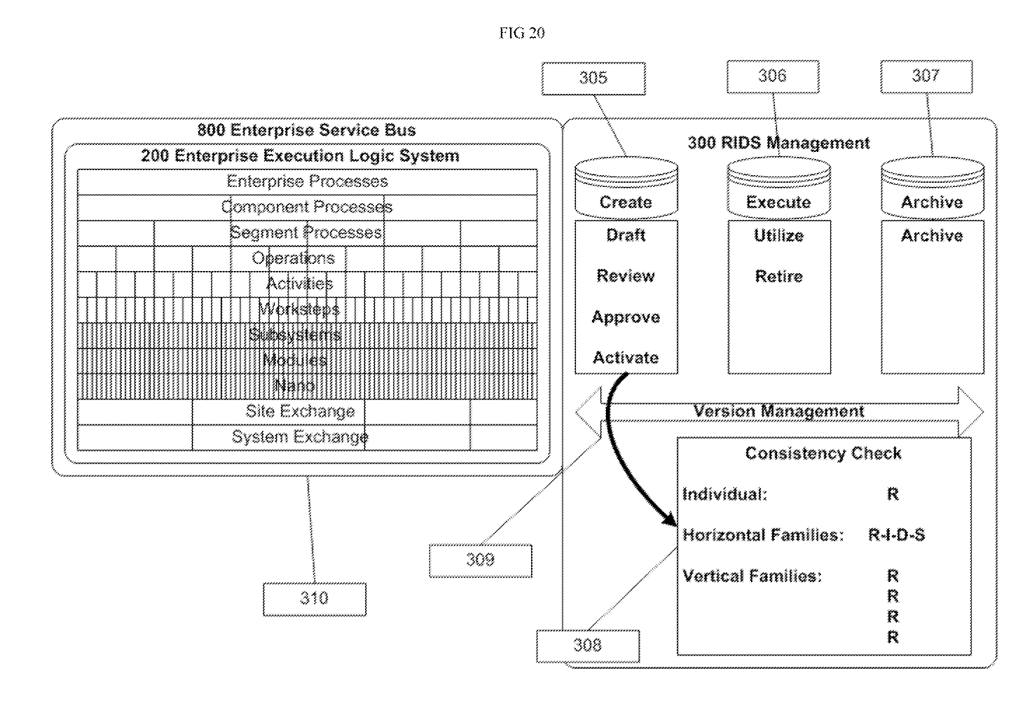

The infrastructure provides specific functional components necessary to execute the life cycle management per FIG. 20. The 305 create function provides the means to build, structure, arrange or load rules, information, data and specifications through managing the draft, review, approve and activate cycle. As part of the create cycle, a 308 consistency check is run to ensure that not only is each discrete rule, information, data or specification valid but so also are their families that represent logical sets. This validation includes horizontal affirmation that for an individual step set of the rules, information, data and specifications are consistent among themselves. Additionally, the system validates the consistency of vertical sets. An example of this would be in the semiconductor industry where a set of recipes [specifications] has to be consistent from beginning to end across 800 operations. The insertion of one incompatible recipe among 800 destroys the product.

The lifecycle management includes additional functions. The 306 execute includes the utilization and retirement of the RIDS while the 307 Archive places the retired RIDS into an archive. Throughout the lifecycle, a 309 version management function controls and tracks the versions. Finally, the lifecycle management is 310 linked to the enterprise execution logic system to drive the execution.

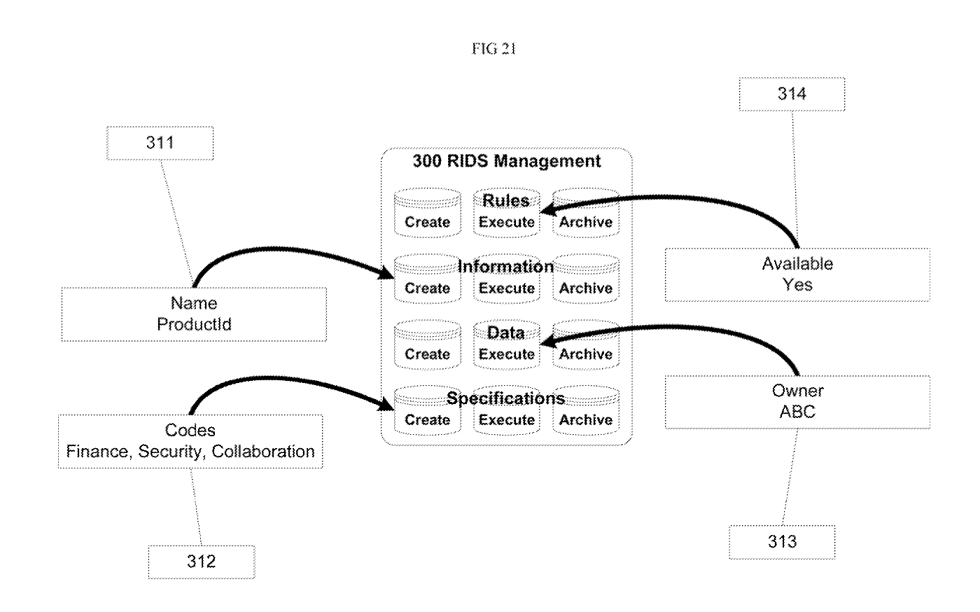

Each rule, information, data or specification component can be qualified so that it integrates more seamlessly into the enterprise execution logic. Per FIG. 21, each element is 311 named so that it can be called from the execution logic. Additionally, each element is marked with a 312 code to guide its use including Finance, Security and Collaboration. Financial marking is important when the use of the elements may be sold to external parties. Security levels are critical for protecting proprietary RIDS while in conjunction with this, collaborative programs for sharing RIDS can be identified. Linking codes such as finance and collaboration or security and collaboration provide the means of adding precision to the use of rules, information, data and specifications. Each element is assigned a 313 owner mark and a Boolean 314 availability indicator to validate if it is loaded for execution. The innovation is this is that it is a holistic service for the enterprise management and use of rules, information, data and specifications.

### 400 Template Creation System

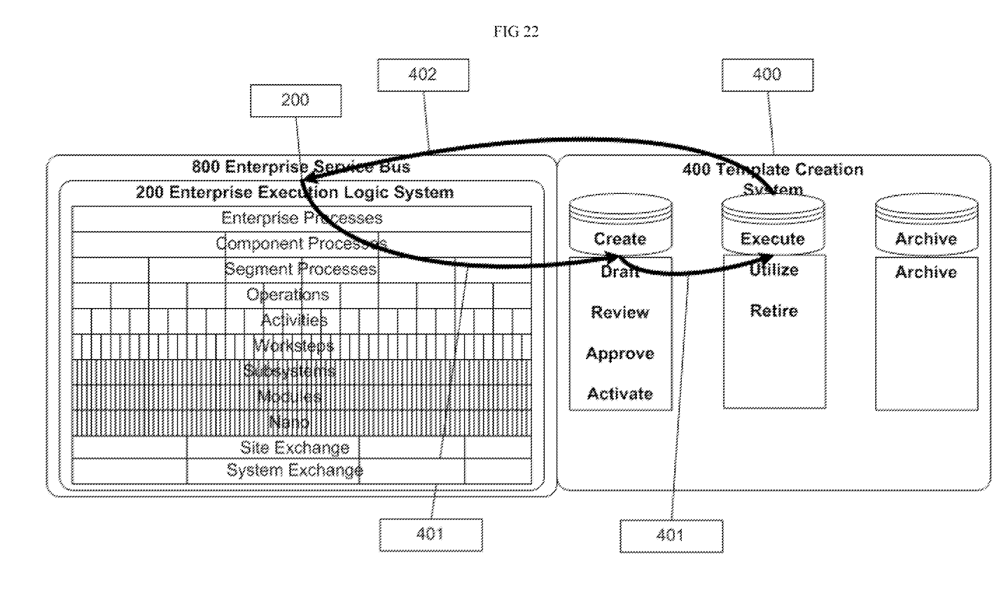

When enterprises determine their best practices, they normally attempt to preserve and apply those practices across their domains. The ten-level architecture therefore provides a 400 template creation system to develop, modify and use repeatable process modules. Per FIG. 22 the 400 template creation system uses the 200 enterprise execution logic for building process templates, 401. When these templates are activated, they are used to execute enterprise processes, 402.

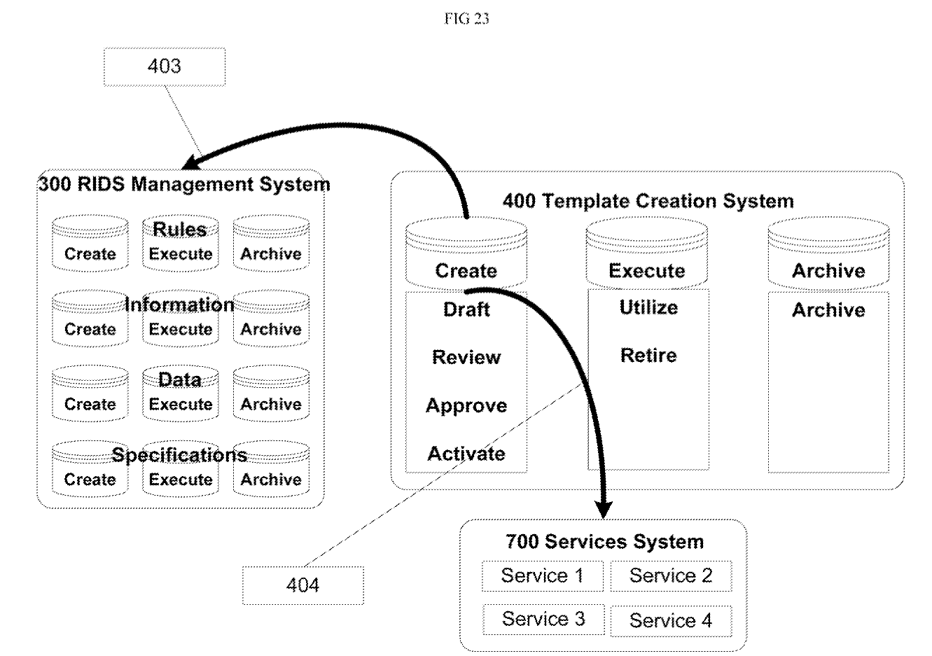

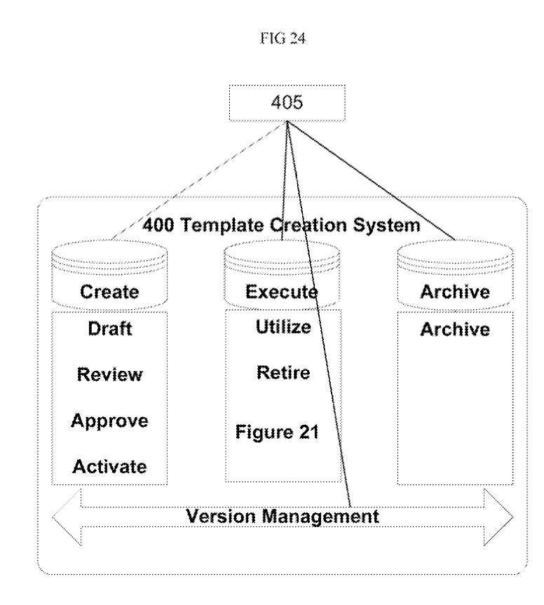

These process templates are built by creating process models in the 200 enterprise execution logic system and linking them to the 300 rules, information, data and specifications management system, 403, and to the 700 Services System, 404 per FIG. 23. As with the 300 RIDS management system, the 400 template creation system provides lifecycle management, naming and coding, 405, per FIG. 24. Enterprises can put this system to effective use. For example, companies that need to collaborate on design can create their best practice template, load this template into the enterprise execution logic system and use the process in common.

The innovation in this system is threefold. First, business process execution has the enterprise execution logic system as a pre-built template itself upon which to develop process templates. Second, the template can name the rules, information, data, specifications and services needed for proper execution. Third, they have the enterprise execution logic system to load the template on for repetitive execution.

### 500 Identification System

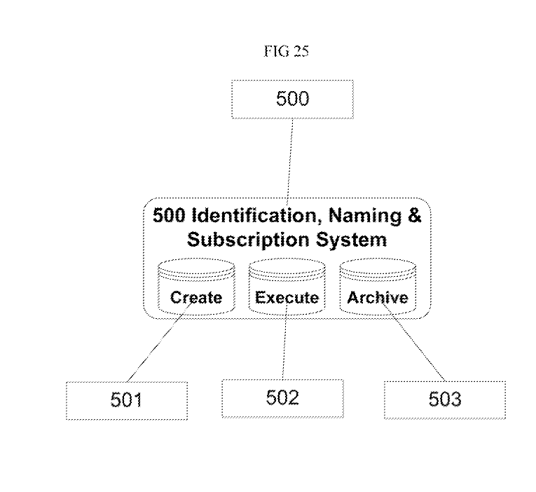

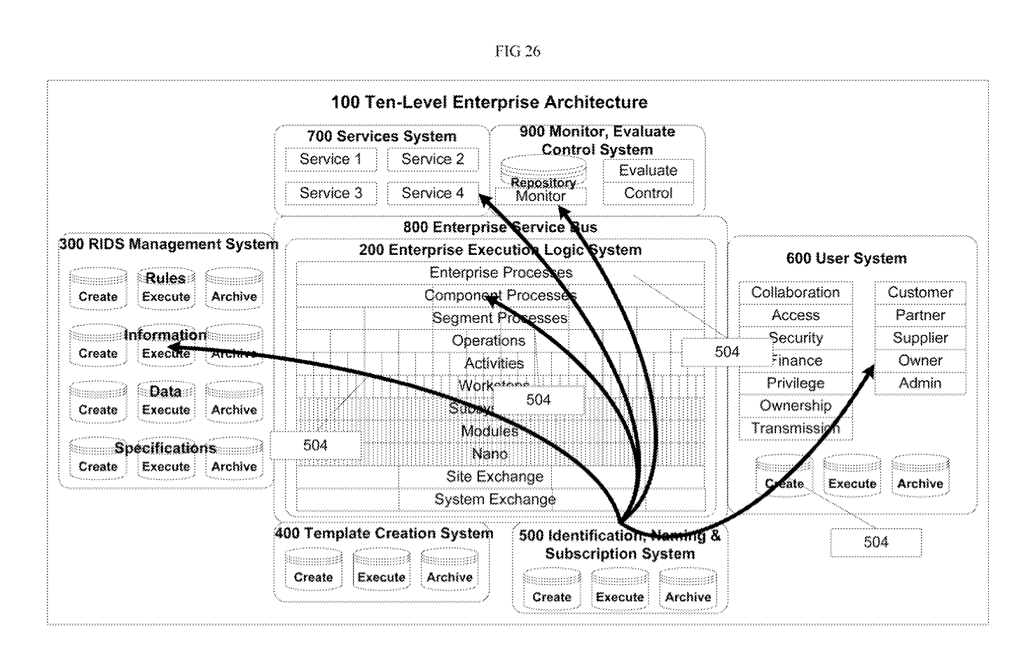

The 500 identification system manages identification lifecycle in the same manner as the 300 RIDS management system using the 501 create, 502 execute and 503 archive structure per FIG. 25. Moreover, per FIG. 26, the 504 identification stores the identity of the logical components of the architecture including the sources and destinations for the users, services, rules, information, data, specifications and the enterprise execution process, steps and cells. As shown below, this identification of components enables robust access for management and execution.

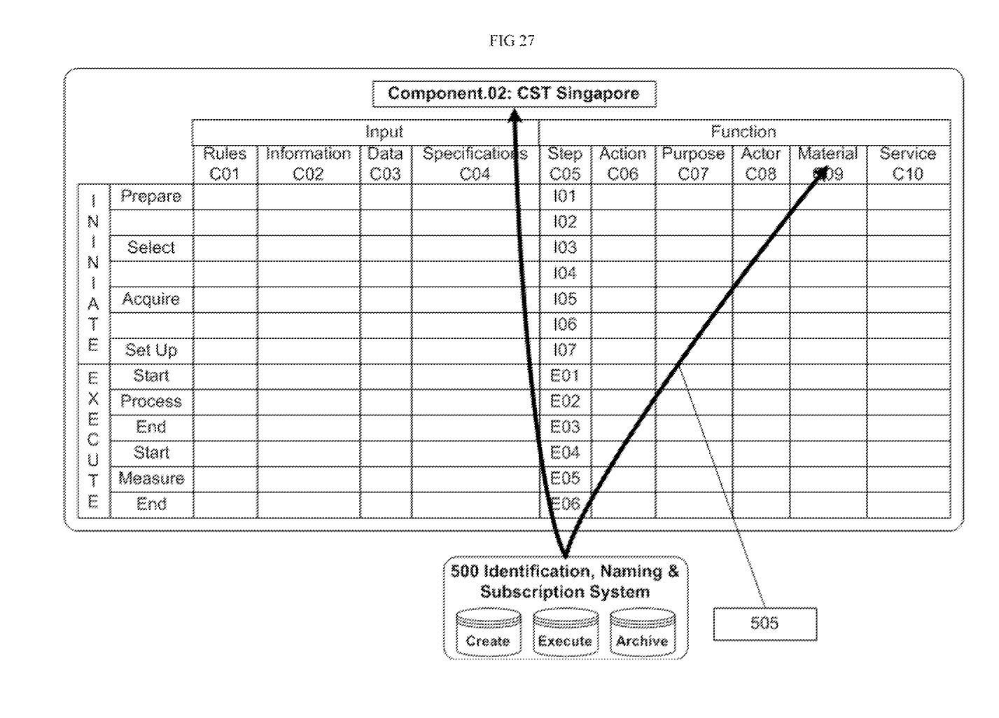

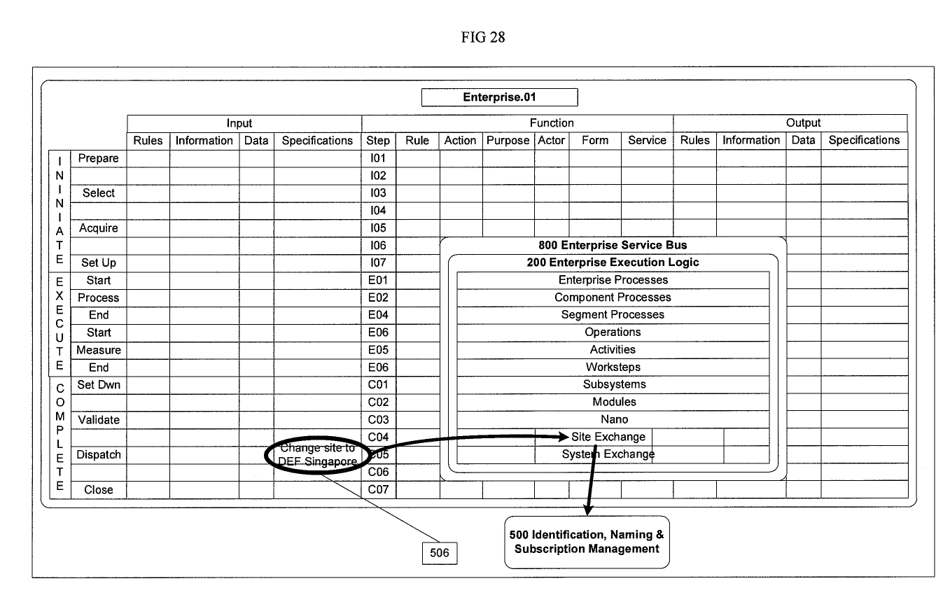

In addition to logical tracking, the identification system maintains physical tracking of components of the architecture. Per FIG. 27, the identification system maintains the physical location of processes and materials. For example, if an insurance claim is outsourced to Bangalore, the 505 process location and the material, the insurance claim, is marked by that location code. Since goods and services can be passed from site to site throughout the lifecycle of creation, it is necessary to track the movement of the process and material as it progresses. One method of accomplishing this within the architecture is to specify the next site 506 location code in the dispatch function specification, FIG. 28. This triggers the use of the site exchange process to manage the transfer.

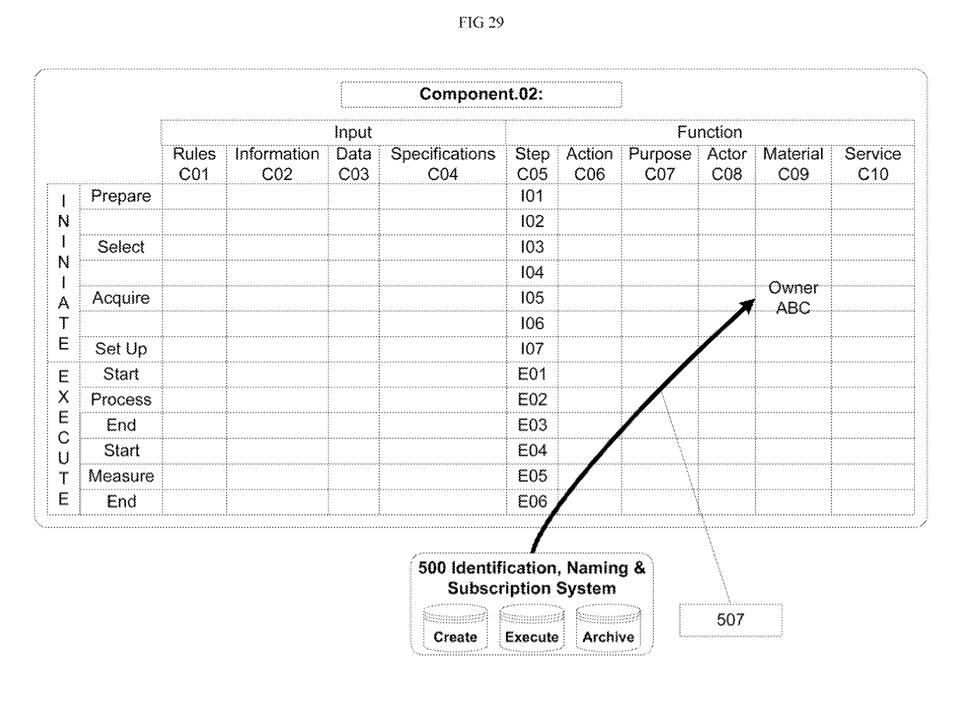

In addition to managing the physical location of material, the 507 ownership function tracks the ownership of the material, FIG. 29. In complex enterprises, materials can be bought, sold and consigned so it is crucial to maintain ownership during the end to end processing since changes of ownership and consignment can require the invocation of alternate sets of rules.

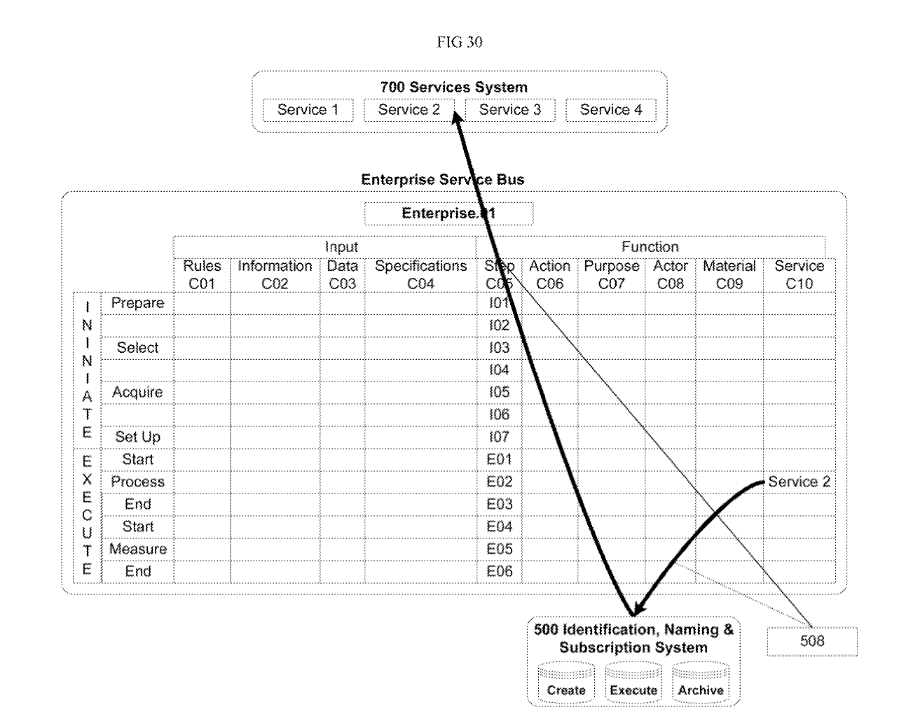

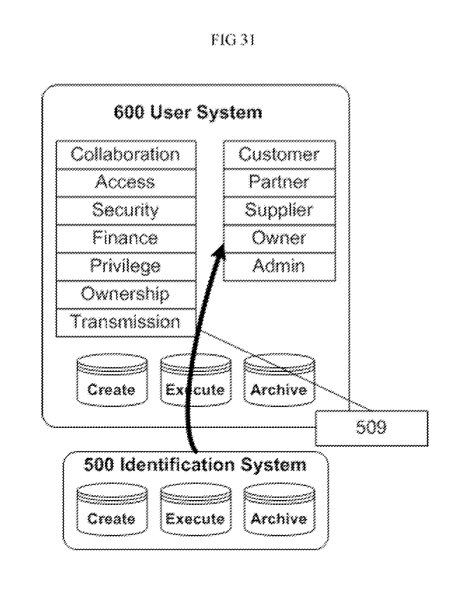

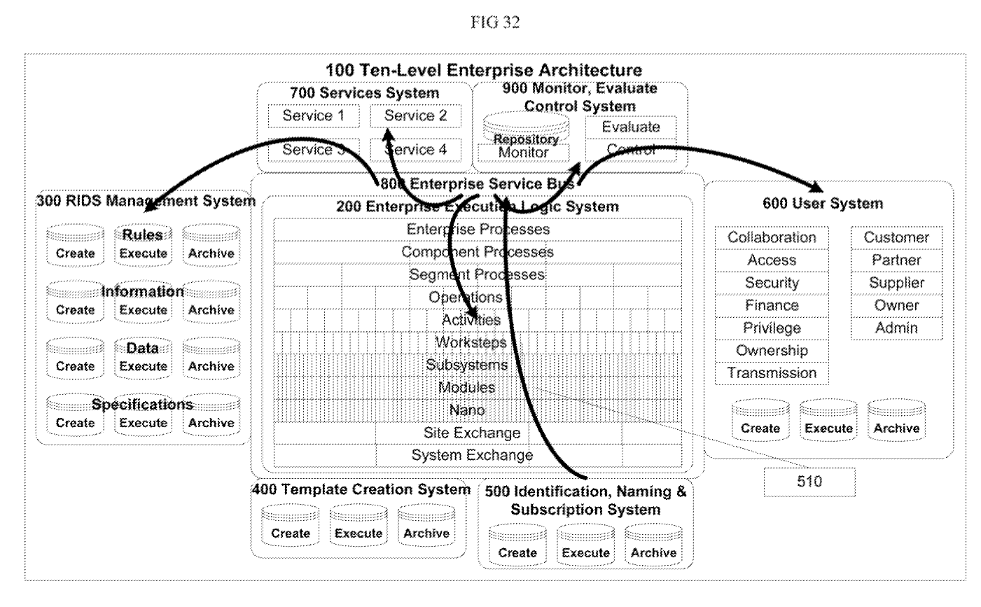

The identification system is the essential element in integrating the architecture. The enterprise execution logic system requests users, services and rules, information, data, specifications by name, 508 FIG. 30, while the identification system maintains the user to ensure their access to the system, 509, FIG. 31. The identification system can identify the system that is executing a process. Last, the identification system is the controlling system for the enterprise service bus, 510 FIG. 32. By supporting all the identification of the components of the architecture, the enterprise service bus can locate and fetch the requested services and components. Since this is a logical system, the components can be distributed widely across geographies, sites and enterprises. The innovation in the identification system is that it provides for the first time an enterprise-wide unified structure attached to all enterprise components.

### 600 User System

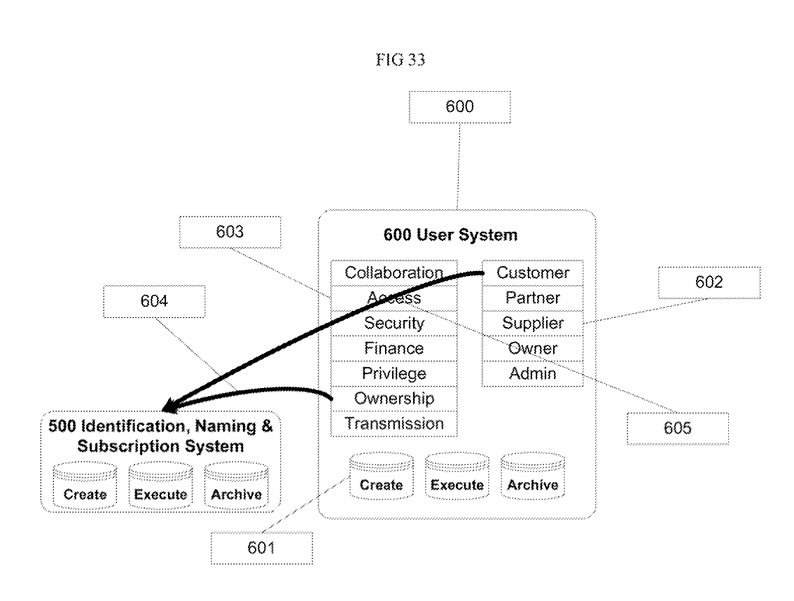

The 600 user system manages the lifecycle of user access and use of the architecture, 601 by multiple classes of users, 602 FIG. 33. In addition to roles, the user system provides the ability to define access and privileges using security, collaboration and financial rules, 603. The users' transmission method is also managed since complex enterprises must find a variety of human and system access appropriate to that user's environment. The assignment of ownership, 604, to the enterprise execution logic processes, cells, rules, information, data, specifications, process templates and services enables a responsible and responsive system. Users of the system such as customers or partners can subscribe 605 to specific processes and templates. The novelty in this capability is that it defines the user's access/non-access or roles with every component of the enterprise process as well as the manner in which they interact with it. The subscription function enables the ten-level architecture to serve as the core of a globally collaborative enterprise.

### 700 Services System

As described in the preceding system descriptions, the architecture provides access to sets of services as required by the business requirements. These services have named owners for management and have distinct logical names so that the enterprise execution logic processes can call them at the appropriate step. Because the naming is logical, the services can reside in a plurality of locations and be substituted simply by changing the name in the process step. The uniqueness in this capability is the complete linkage of the services to the top to bottom, end to end and site to site execution logic.

### 800 Enterprise Service Bus

The architecture uses an enterprise service bus to provide virtual access to all of the components of the ten-level architecture. The enterprise service bus relies on the identification system to manage the location of the resources.

### 900 Monitor and Control System

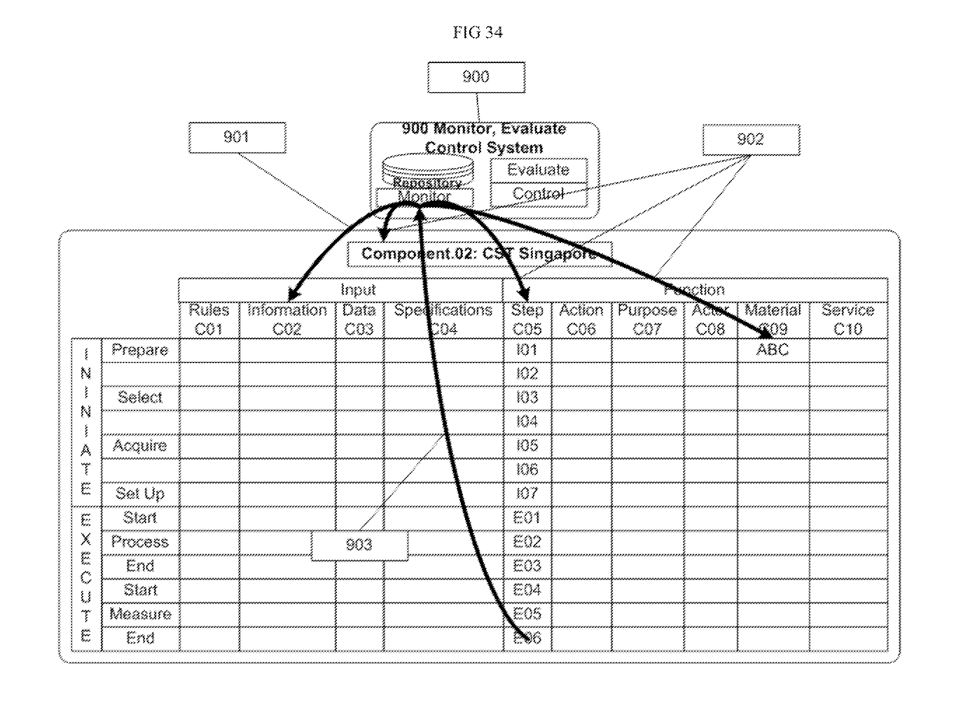

In order to provide the enterprise with the ability to use the architecture to respond to real external events, the 900 monitor and control system allows the means of response. The monitor component allows users to view the current state of the enterprise execution logic system's processes, steps and cells per 901 in FIG. 34. Additionally, the 902 function allows users to view the exact process and step location of named material under processing. At the end of a process, the history of a named material process is stored, 903.

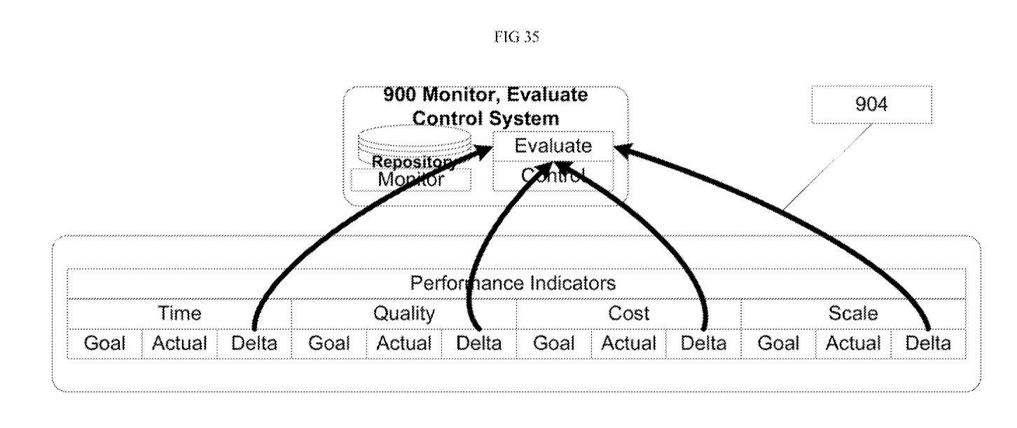

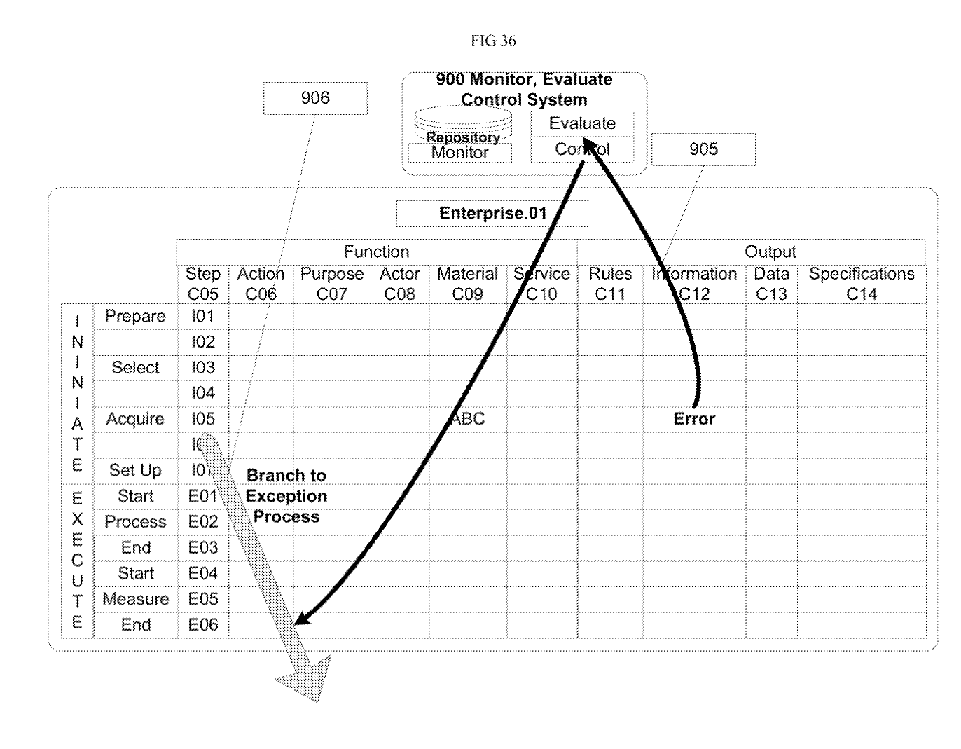

The evaluate function uses the performance indicators provides powerful management, FIG. 35. Through the monitor function, the evaluate function collects the delta performance indicators, 904, to respond to excessive process variance or aberrations and to provide status conditions to the control function. The evaluate function can also detect process error conditions, 905 and alert the control function for action such as exception processing, 906, FIG. 36.

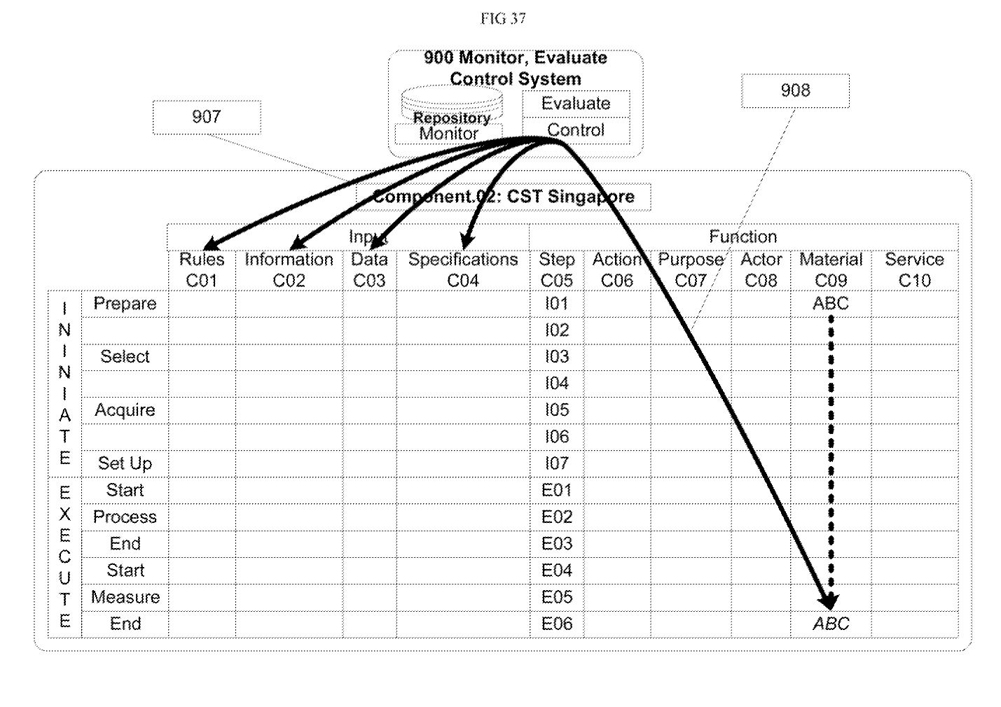

Besides managing process variances and errors, the control function provides two types of in control process overrides for named materials, FIG. 37. For specific named material, the process step contents of the input rules, information, data or specifications can be overridden, 907. This is created by providing a temporary override repository in the 300 RIDS management system. Second, named material can be halted at its current process step or a future process step as well as be restarted, 908.

The novelty in this function is that when it is coupled with the enterprise execution logic system and the 300 RIDS management system, it allows the enterprise to monitor, to evaluate and to take control of any type of material—product or service—at any time or place throughout the domain of the enterprise.

While various inventive aspects have been particularly shown and described with reference to exemplary embodiments. The embodiments and terms have been used to explain various features and aspects and should not be construed as limiting the scope of the claims. The exemplary embodiments should be considered in a descriptive sense only and not for purposes of limitation.

What is claimed is:

1. A method of systematically performing a process in a multi-level hierarchy, the method comprising:
performing an initiate operation, wherein the initiate operation comprises an initiate input operation, an initiate function operation, and an initiate output operation;
performing an execute operation, wherein the execute operation comprises an execute input operation, an execute function operation, and an execute output operation, and
performing a complete operation, wherein the complete operation comprises a complete input operation, a complete function operation, and a complete output operation.

2. The method of claim 1, wherein:
the initiate input operation comprises managing initiate input rules, initiate input information, initiate input data, and initiate input specifications,
the initiate function operation comprises managing initiate function ordering, at least one initiate function action, at least one initiate function purpose, at least one initiate function actor, at least one initiate function material, and at least one initiate function service,
the initiate output operation comprises managing initiate output rules, initiate output information, initiate output data, and initiate output specifications,
the execute input operation comprises managing execute input rules, execute input information, execute input data, and execute input specifications,
the execute function operation comprises managing execute function ordering, at least one execute function purpose, at least one execute function actor, at least one execute function material, and at least one execute function service,
the execute output operation comprises managing execute output rules, execute output information, execute output data, and execute output specifications,
the complete input operation comprises managing complete input rules, complete input information, complete input data, and complete input specifications,
the complete function operation comprises managing complete function ordering, at least one complete function purpose, at least one complete function actor, at least one complete function material, and at least one complete function service, and
the complete output operation comprises managing complete output rules, complete output information, complete output data, and complete output specifications.

3. The method of claim 2, wherein:
each of the initiate input, function, and output operations respectively comprise:
a prepare operation,
a select operation,
an acquire operation, and
a set up operation,
each of the execute input, function, and output operations respectively comprise:
a process operation, and
a measurement operation, and
each of the complete input, function, and output operations respectively comprise:
a set down operation,
a validate operation,
a dispatch operation, and
a close operation.

4. The method of claim 1, wherein:
the initiate operation further comprises an initiate performance indication operation,
the execute operation further comprises an execute performance indication operation,
the complete operation further comprises a complete performance indication operation.

5. The method of claim 4, wherein each of the initiate, execute, and complete performance indication operations respectively comprise:
measuring a time,
measuring a quality,
measuring a cost, and
measuring a scale.

6. The method of claim 5, wherein each of the time, quality, cost, and scale measurements comprise comparing an actual measurement with a goal to determine a difference between the actual and the goal.

7. The method of claim 4, wherein:
the initiate operation further comprises an initiate innovation operation,
the execute operation further comprises an execute innovation operation,
the complete operation further comprises a complete innovation operation.

8. The method of claim 7, wherein each of the initiate innovation operation, the execute innovation operation, and the complete innovation operation respectively comprise:
a strategy change operation,
a process change operation,
an organization change operation, and
a technology change operation.

9. The method of claim 1, further comprising performing initiate, execute, and complete operations for each level in the multi-level hierarchy.

10. The method of claim 1, further comprising performing initiate, execute, and complete operations for each of multiple sites.

11. A system configured to systematically perform a process in a multi-level hierarchy, the system comprising:
an initiate system configured to perform an initiate operation, wherein the initiate operation comprises an initiate input operation, an initiate function operation, and an initiate output operation;
an execute system configured to perform an operation, wherein the execute operation comprises an execute input operation, an execute function operation, and an execute output operation, and
a complete system configured to perform a complete operation, wherein the complete operation comprises a complete input operation, a complete function operation, and a complete output operation.

12. The system of claim 11, wherein:
the initiate input operation comprises managing initiate input rules, initiate input information, initiate input data, and initiate input specifications,
the initiate function operation comprises managing initiate function ordering, at least one initiate function action, at least one initiate function purpose, at least one initiate function actor, at least one initiate function material, and at least one initiate function service,
the initiate output operation comprises managing initiate output rules, initiate output information, initiate output data, and initiate output specifications,
the execute input operation comprises managing execute input rules, execute input information, execute input data, and execute input specifications,
the execute function operation comprises managing execute function ordering, at least one execute function purpose, at least one execute function actor, at least one execute function material, and at least one execute function service,
the execute output operation comprises managing execute output rules, execute output information, execute output data, and execute output specifications,
the complete input operation comprises managing complete input rules, complete input information, complete input data, and complete input specifications,
the complete function operation comprises managing complete function ordering, at least one complete function purpose, at least one complete function actor, at least one complete function material, and at least one complete function service, and
the complete output operation comprises managing complete output rules, complete output information, complete output data, and complete output specifications.

13. The system of claim 12, wherein:
each of the initiate input, function, and output operations respectively comprise:
a prepare operation,
a select operation,
an acquire operation, and
a set up operation,
each of the execute input, function, and output operations respectively comprise:
a process operation, and
a measurement operation, and
each of the complete input, function, and output operations respectively comprise:
a set down operation,
a validate operation,
a dispatch operation, and
a close operation.

14. The system of claim 11, wherein:
the initiate system is further configured to perform an initiate performance indication operation,
the execute system is further configured to perform an execute performance indication operation,
the complete system is further configured to perform a complete performance indication operation.

15. The system of claim 14, wherein each of the initiate, execute, and complete performance indication operations respectively comprise:
measuring a time,
measuring a quality,
measuring a cost, and
measuring a scale.

16. The system of claim 15, wherein each of the time, quality, cost, and scale measurements comprise comparing an actual measurement with a goal to determine a difference between the actual and the goal.

17. The system of claim 14, wherein:
the initiate system is further configured to perform an initiate innovation operation,
the execute system is further configured to perform an execute innovation operation,
the complete system is further configured to perform a complete innovation operation.

18. The system of claim 17, wherein each of the initiate innovation operation, the execute innovation operation, and the complete innovation operation respectively comprise:
a strategy change operation,
a process change operation,
an organization change operation, and
a technology change operation.

19. The system of claim 11, wherein the initiate, execute, and complete systems are respectively further configured to perform initiate, execute, and complete operations for each level in the multi-level hierarchy.

20. The system of claim 11, wherein the initiate, execute, and complete systems are respectively further configured to perform initiate, execute, and complete operations for each of multiple sites.
